(19) United States
(12) Patent Application Publication
(10) Pub. No.: US 2012/0328507 A1
(43) Pub. Date: Dec. 27, 2012

(54) REDUCED MOISTURE CHEMICAL REACTIONS

(76) Inventors: Andrew HILL, Nottingham (GB); John HILL, Sheffield (GB)

(21) Appl. No.: 13/252,527

(22) Filed: Oct. 4, 2011

Related U.S. Application Data
(63) Continuation of application No. 11/569,887, filed on Dec. 1, 2006, now abandoned.

(30) Foreign Application Priority Data
Jun. 1, 2004 (GB) 0412211.5

(51) Int. Cl. C01G 23/04; C01B 13/14

(52) U.S. Cl. 423/608; 423/579

(57) ABSTRACT

A method of continuously producing reduced compounds, which comprises continuously feeding our oxidised compound into a reaction chamber and contracting the oxidised compound with a reductant gas. The oxidised compound may be titanium dioxide. The reaction chamber may be a rotating kiln.

This invention relates to the production of compounds via reactions which are adversely affected by high water concentrations.

One important commercial chemical reaction is the conversion of titanium dioxide into titanium suboxide materials (TiₙO₂ₙ₋₁), according to the following reversible reaction:

nTiO₂+H₂=TiₙO₍₂ₙ₋₁₎+H₂O (1)

In the discussion below, the conversion of titanium dioxide to the suboxide is referred to as the forward reaction, and as proceeding to the right.

Titanium suboxide materials are important commercially because some are electrically conductive and/or highly corrosion resistant. The suboxide materials have found considerable utility in electrochemical systems, such as sensors, electrochemical synthesis, water treatment, fuel cells and batteries.

In quantities of up to, say, 100 kg, titanium suboxide materials are usually manufactured in a batch furnace where an aliquot of titanium dioxide powder is heated to a temperature in excess of 1000° C. under a reducing atmosphere (hydrogen being indicated above in (1)).

EP 0478152 discloses one such batch process for the production of titanium suboxides in which titanium dioxide is placed on a graphite sheet in a furnace and hydrogen gas is passed into the furnace whilst heating to 1200° C.

U.S. Pat. No. 2,848,303 discloses the reduction of titanium dioxide by mixing it with carbon and heating in the presence of hydrogen.

As will be appreciated, for each value of n, the equilibrium constant is a function of hydrogen and water partial pressure. Therefore, by increasing the hydrogen partial pressure and/or reducing the water partial pressure the reaction will be driven to the right.

Also, the reaction (1) is endothermic and thus requires a continuous source of heat for the forward reaction to proceed.

The thermodynamics of the system indicates that only two solid phases will be present at any single set of equilibrium conditions and that high temperature will favour the forward reaction when ‘n’ is small (overcoming entropy considerations).

In the conventional batch furnace, the aliquot of titanium dioxide is static and consequently different parts of the aliquot are exposed to different conditions, (temperature, hydrogen and water partial pressures). This differential exposure means that the product is normally a mixture of titanium suboxides. For example, the material on the outside of the aliquot (where mass and energy transfer is relatively unhindered) will be reduced more than that located in the centre of the aliquot (where hydrogen transport to and water transfer from is relatively hindered).

Typically the material on the surface of a static aliquot may contain Ti₃O₅ or Ti₄O₇ and the material at the centre of the aliquot may consist of Ti₈O₁₅, Ti₉O₁₇ or Ti₁₀O₁₉, or even higher.

The electrical and chemical properties of each suboxide (i.e. different values of n) vary significantly. It is usually desirable to maximize the production of a particular required suboxide, whilst minimizing production of the others. For example, Ti₄O₇ and Ti₅O₉ have the highest electrical conductivity and, therefore, these have particular utility in batteries. Ti₃O₅ and Ti₂O₃ have a low conductivity and are significantly attacked chemically by many of the electrolytes used in batteries (e.g. H₂SO₄), forming titanate ions, which is detrimental to both the mechanical structure of the battery and the chemical operation. Accordingly, for battery applications it is desirable to maximize Ti₄O₇ and Ti₅O₉ production whilst minimizing Ti₃O₅ and Ti₂O₃ production.

It is generally not possible to physically segregate the different suboxides once manufactured and thus it is highly desirable to improve the manufacturing process to improve the heat and mass transport so that the production of the desired suboxide(s) is (are) as high as possible.

Chemical engineers have sought to improve heat and mass transport in other processes by designing continuous systems where a solid phase is moved with respect to the gas and/or agitated to ensure the uniformity of experienced conditions throughout the solid phase.

Common equipment includes tubular rotating kilns, fluidized beds, falling dense beds, and free-falling particle systems and like systems. These systems may be directly heated by a burner, the hot combustion gases from which flow inside the reaction chamber to maintain the reaction temperature. Other, indirect, heating systems are also known where heat, generated by a burner or by electrical heating, flows by conduction through the walls of the reaction chamber to maintain the reaction temperature.

It is not generally feasible to design an indirectly fired furnace with an operating temperature greater than about 1200° C. because this exceeds the maximum operating temperature of most metals used in construction.

Furnaces that operate above 1200° C. are generally restricted to the directly fired type. This is a highly efficient technique to transfer heat. However, combustion gases from convenient fuels (such as hydrocarbons or hydrogen) contain moisture and those using hydrocarbon fuels also contain carbon oxides.

In systems where hydrogen is used (as a reductant at high temperatures), it is preferable not to have carbon dioxide present due to the following reaction:

CO+H₂O=CO₂+H₂ (2)

This means that direct feed burners are inappropriate or difficult to use in high temperature applications where hydrogen is used as CO₂ limits the amount of hydrogen available. Also, it is noted that water is generated when hydrocarbons or hydrogen is burnt and when CO₂ and H₂ reacts.

Accordingly, it is an object of the invention to overcome or at least reduce one or more of the problems associated with the prior art when carrying out reactions at high temperature and/or carrying out reactions where one or more reactants (or products) are sensitive to moisture.

It is a more particular, but not exclusive, object of the invention to provide a reaction furnace which can operate at temperatures above 1200° C.

It is a further object to provide apparatus which can produce reduced species continuously.

It is a further particular, but not exclusive, object of the invention to provide a method of, and furnace for, the production of suboxides, e.g. titanium suboxides.

It is a further non-exclusive object of the invention to provide methods of producing substances via reactions which are sensitive to water concentrations more efficiently and in a more controlled fashion.

There is provided, in a first aspect of the invention, a method of continuously producing a pre-determined suboxide, the method comprising continuously feeding an oxide starting material into a reaction chamber and contacting the so-fed oxide with a substantially moisture-free gas and collecting the pre-determined suboxide.

A second aspect of the invention provides a method of continuously producing reduced compounds, the method comprising continuously feeding an oxidised compound into a reaction chamber and contacting the so fed compound with a substantially moisture-free reductant gas heated to a temperature in excess of 1200° C. and continuously collecting the reduced compound.

Preferably, the oxidized compound is titanium dioxide and the reduced compound is a titanium suboxide.

The gas may comprise one or more of hydrogen, carbon, carbon monoxide, methane, propane or other hydrocarbons.

The gas will preferably be heated by a plasma torch or by microwave energy.

A third aspect of the invention provides a method of forming titanium suboxides, the method comprising continuously feeding titanium dioxide into a reaction chamber, the chamber comprising a moisture-free reducing atmosphere heated to above 1200° C.

Preferably, the reducing atmosphere is provided by a reductant gas. The heat may be supplied to the gas using a plasma torch or microwave energy.

A further aspect of the invention provides apparatus for the reaction of a solid compound or compounds at temperatures in excess of 1200° C., the apparatus comprising a reaction chamber to hold a solid reactant compound through which the solid reactant compound moves and heating means to supply a source of heat which is substantially water-free and is arranged to heat the reaction chamber to a temperature in excess of 1200° C.

A more particular aspect of the invention provides apparatus for the reduction of a solid reactant at temperatures in excess of 1200° C., the apparatus comprising a reaction chamber to hold the solid reactant and through which the solid reactant moves and heating means to supply a source of heat which is substantially water-free and is arranged to heat the reaction chamber to a temperature in excess of 1200° C.

The reaction chamber may be one of a rotating tube kiln, a vertical static tube kiln, a fluidized bed or other suitable type as known to the skilled addressee.

Preferably, the apparatus comprises means to continuously feed the reactant to the reaction chamber. The apparatus may also comprise means to continuously collect the product from the reaction chamber.

The heating means is preferably one of a plasma torch or a microwave source.

The apparatus may further comprise a reactant source arranged to allow a reactant to be transported (e.g. flow) into the reaction chamber.

Preferably, the heating means is arranged to heat the reactant before it enters the reaction chamber.

In a preferred embodiment the reactant is a gas, most preferably a gas to provide a reducing atmosphere within the reaction chamber, for example hydrogen and/or carbon monoxide, in any case gases which comprise metals will not be used.

A reactant compound may be placed within the reaction chamber prior to reaction occurring. The reactant compound is preferably titanium dioxide.

The apparatus may further comprise means to add other species to the reaction chamber which react with any water present to reduce the concentration thereof, e.g. carbon, carbon monoxide. Hydrocarbons, such as methane, ethane, propane, butane, ethane, propene, butene etc. may also be added.

In order that the invention may be more fully understood, it will now be described, by way of example only, and with reference to the accompanying drawings, in which:

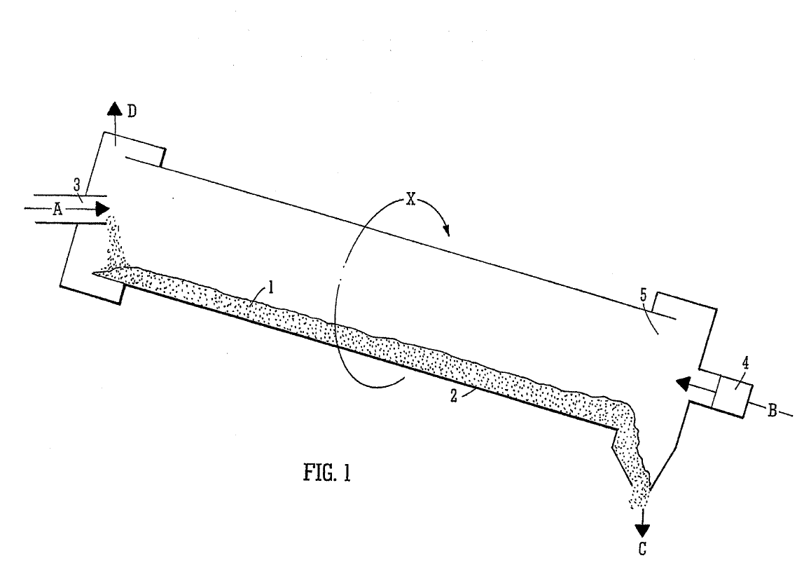

FIG. 1 shows a schematic representation of a rotary kiln apparatus according to the invention;

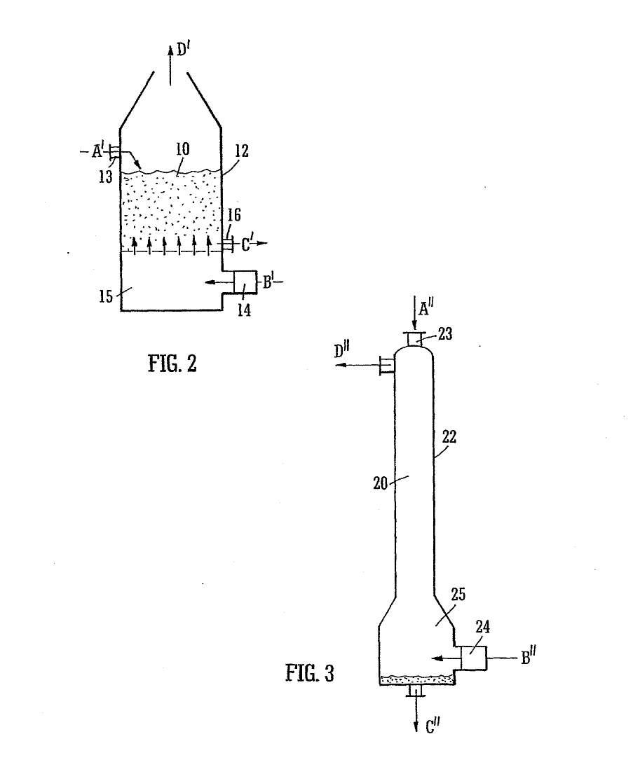

FIG. 2 shows a schematic representation of a fluidized bed reactor according to the invention; and

FIG. 3 shows a schematic representation of a free fall drop tube furnace according to the invention.

Referring to FIG. 1, there is shown apparatus for the continuous reduction of reactants 1 comprising a rotary kiln 2 arranged to be rotated about its major axis in the direction of arrow X. Solid material, for example, titanium dioxide, is continuously fed into the kiln 2 at a first end 3, as indicated by arrow A. A plasma torch 4 is arranged to heat a continuous stream of hydrogen gas, indicated by arrow B, which is introduced to the kiln 2 at the opposite end 5 of the kiln 2.

The kiln 2 comprises a steel shell lined with a refractory liner of alumina blocks (not shown). The kiln 2 is also provided with alumina ‘lifters’ (not shown) which encourage the flow of solid material from the first end 3 to the second end 5 of the kiln 2. The thickness of the refractory liner will be chosen so that the steel shell experiences temperatures well within its mechanical and structural limits (e.g. about 200° C.)

The hydrogen gas B ensures that the atmosphere within the kiln 2 is reducing. Accordingly, titanium suboxide is output from the kiln at the second end 5, as indicated by arrow C, in accordance with reaction (1) above. Excess gas containing the moisture of the reaction leaves as shown by arrow D.

FIG. 2 shows another apparatus for the continuous reduction of reactants 10 comprising fluidized bed reactor 12. Titanium dioxide is continuously fed into the reactor 12 at the top 13, as indicated by arrow A′.

The reactor 12 comprises a steel shell lined with a refractory liner of alumina blocks (not shown). Again, the thickness of the refractory liner will be chosen so that the steel shell experiences temperatures well within its mechanical and structural limits (e.g. about 200° C.).

A plasma torch 14 is arranged to heat a continuous stream of hydrogen gas, indicated by arrow B′, which is introduced to the reactor 12 into a plenum chamber 15 at the base of the reactor 12. The heated hydrogen B′ percolates upwards through the reactor 12 fluidising the mass of reactant A′ as it rises.

The hydrogen gas B′ ensures that the atmosphere within the reactor 12 is reducing. Accordingly, titanium suboxide is output from the reactor 12 via an output 16, as indicated by arrow C′, in accordance with reaction (1) above. Excess gas containing the moisture created in the reaction leaves as indicated by arrow D′

FIG. 3 shows further apparatus for the continuous reduction of reactants 20 comprising free-fall drop-tube reactor 22. Titanium dioxide is continuously fed into the reactor 22 at the top 23, as indicated by arrow A″ and falls under gravity toward the base of the reactor 22.

The reactor 22 comprises a steel shell lined with a refractory liner of alumina blocks (not shown). Again, the thickness of the refractory liner will be chosen so that the steel shell experiences temperatures well within its mechanical and structural limits (e.g. about 200° C.).

A plasma torch 24 is arranged to heat a continuous stream of hydrogen gas, indicated by arrow B″, which is introduced to the reactor 22 into a chamber 25 at the base of the reactor 22. The heated hydrogen B″ flows upwards through the reactor 22 encountering the falling reactant A″ as it falls.

The hydrogen gas B″ ensures that the atmosphere within the reactor 22 is reducing. Accordingly, titanium suboxide is output from the reactor 22 via an output 26, as indicated by arrow C″, in accordance with reaction (1) above. Excess gas, containing the moisture of reaction leaves as shown by arrow D″

In each set of the above apparatus 1, 10, 20 carbon monoxide can be added to the hydrogen gas stream B, B′, B″. The CO will react with any water present via reaction (2) above. Also, carbon may be added to the feed TiO₂ to react with any water via the following reactions:

C+H₂O=CO+H₂ (3)

C+2H₂O=CO₂+2H₂ (4)

It will be appreciated from the drawings that the reactants are fed counter currently to one another, it will be understood that this is the most preferred arrangement as it ensures that the ‘most reduced’ solid reactants come into contact with the ‘driest’ hydrogen. However, other arrangements are to be understood as being within the scope of the invention (co-current flows, orthogonal flows and so on).

It can be shown from thermodynamic calculations (see Eriksson and Pelton; Mett. Trans. B.; 24B (1993) pp 795-805) that to achieve an equilibrium composition of Ti₅O₉ using 5 moles of H₂ per mole of TiO₂ an operating temperature of about 1400° C. would be required.

By way of a comparison, if the feed hydrogen contained 5 v/v % H₂O along with the carbon oxides from a methane burner using 10% excess air, the required equilibrium temperature is raised to 1650° C. This temperature is very dose to the melting points of titanium suboxides and is likely to generate problems of agglomeration. Accordingly, it is desirable to reduce the temperature to effect satisfactory reclamation of the product, to reduce operating costs and to increase the service life of the apparatus.

It can also be shown that a reaction run to equilibrium with dry hydrogen at 1500° C. will produce Ti₄O₇ and requires about 6.6 moles of H₂ per mole of TiO₂. Using the prior art burner mentioned above, at 1500° C., the equilibrium concentration will be a mixture of Ti₉O₁₇ and Ti₁₀O₁₉. To produce Ti₄O₇ using the prior art burner requires a three-fold increase in the amount of hydrogen used.

Accordingly, it has been shown that by using a substantially moisture-free source of heat, the operating temperatures can be reduced or the amount of reactants can be reduced. In either case, the invention makes the continuous fabrication of titanium suboxides more economical than has heretofore been achievable.

It will be appreciated that although the above description relates to the reduction of TiO₂ there are many other reactions which could benefit from this invention. Any reactant or product which is sensitive to moisture may benefit when reacted under a reducing atmosphere. More than one solid reactant may be fed into the reaction chamber. Other suboxides may be fabricated. Other reductant gases which do not comprise metals (e.g. magnesium, sodium and so on) may be utilised.

1-17. (canceled)

18. A method of continuously producing a suboxide, the method comprising continuously feeding an oxide starting material into a reaction chamber, countercurrently feeding a substantially moisture free reductant gas into the reaction chamber and contacting the so-fed oxide with the reducant gas and continuously collecting the suboxide, the method further comprising adding another species to the reaction chamber which reacts with any water present to reduce the concentration thereof, wherein the another species comprises one or more of carbon monoxide, or a hydrocarbon, such as methane, ethane, propane, butane, ethane, propene or butene.

19. A method according to claim 18, wherein the oxide is titanium dioxide and the suboxide compound is a titanium suboxide.

20. A method according to claim 18, wherein the gas comprises one or more of hydrogen, carbon, carbon monoxide, methane, propane or other hydrocarbons.

21. A method according to claim 18, comprising heating the gas by a plasma torch or by using microwave energy.

22. A method according to claim 18, comprising heating the reductant gas before it enters the reaction chamber.

23. A method according to claim 18, comprising heating the reductant gas to a temperature sufficient to heat the chamber to above 1200° C.

24. A method of forming titanium suboxides, the method comprising continuously feeding titanium dioxide into a reaction chamber, countercurrently feeding a substantially moisture free reductant gas into the reaction chamber providing a moisture-free reducing atmosphere heated to above 1200° C. within the chamber, the method further comprising adding another species to the reaction chamber which reacts with any water present to reduce the concentration thereof.

25. A method according to claim 24, comprising heating the reductant gas using a plasma torch or microwave energy.
